(19) United States
(12) Patent Application Publication
(10) Pub. No.: US 2003/0074315 A1
(43) Pub. Date: Apr. 17, 2003

(54) System and apparatus for remotely printing certified documents

(75) Inventor: Steven S. Lam, Brooklyn, NY (US)

Correspondence Address: OSTROLENK FABER GERB & SOFFEN, 1180 AVENUE OF THE AMERICAS, NEW YORK, NY, 100368403

(73) Assignee: Sterling National Bank

(21) Appl. No.: 10/272,867

(22) Filed: Oct. 16, 2002

Related U.S. Application Data
(60) Provisional application No. 60/329,867, filed on Oct. 16, 2001.

(51) Int. Cl. G06F 17/60

(52) U.S. Cl. 705/42

(57) ABSTRACT

A communication system for remotely and securely printing certified checks via the Internet includes a customer communication device operative to initiate communication with a web server which is in communication with a system bank capable of creating an image file of the certified check which is securely encrypted and transmitted back to the customer via the Internet.

### CROSS REFERENCE TO RELATED APPLICATIONS

This application claims the benefit and priority of U.S. Provisional Application No. 60/329,867 filed Oct. 16, 2001 and entitled “Communication System For Requesting, Issuing And Printing Certified Checks Between Central And Remote Locations”, and which is incorporated herein by reference.

### FIELD OF THE INVENTION

The present invention relates to commercial and other electronic activities involving a trusted electronic go-between process to request, audit, validate, and direct electronic transactions. Particularly, the invention relates to a certified-check, computer-based bank disbursing system capable of printing certified checks at remote locations and a method of implementing this system.

### BACKGROUND OF THE INVENTION

The advent of computer technology brought incomparable convenience into our lives. For example, electronic communication with banks and on-line investments are just a very few activities that have become today's reality. However, there are still many routines that seem to be obsolete. For instance, more than 70% of Americans own their residences. Each real estate transaction requires that buyers and sellers undergo a tedious, long process of filling out and exchanging numerous documents including bank checks. Typically, a business transaction in general, and a real estate conveyance in particular, provides a procedure in which the checks, exchanged between the parties for different purposes, are to be certified. A certification process, in turn, necessitates the payer to appear at the bank, present his or her identification documents, and name a payee to whom the bank issues a check drawn on the payee's account. The check must bear a certified number and a signature of a bank officer. Needless to say, such a well-established procedure is typically time consuming.

Perhaps no other stage of a real estate transaction is so intimately linked to the exchange of documents as final closing. The closing is the proceeding at which the parties exchange executed instruments and make required payments. Disbursements must be made and documents distributed to the parties entitled to receive them. Typically, a lawyer who handles the closing attends to all or virtually all of these details including necessary visits to the bank to receive certified checks, which consume the lawyer's or the lawyer's assistant's time and contribute to the high cost of closing.

Known systems utilized by banks for printing documents, which are required by customers, are totally internal and, thus, have no capability of printing an ordered, verified, and certified document at a remote location.

What is desired, therefore, is an automatic communication system providing a remote printing of certified checks on demand. Also, an automatic communication system capable of automatically identifying a requester of a certified check, preparing an image file of the certified check and redistributing demanded funds between the requester's account and an official bank account is desirable as well. Furthermore, a dedicated or public communication system for remote printing of certified checks providing an efficient, secure, and inexpensive transaction between bank and lawyer is also needed.

### SUMMARY OF THE INVENTION

It is, therefore, an object of this invention to provide a communication system that is capable of remote printing of a certified document in real time after the requestor has contacted the issuer of the certified document via the communication system.

A further object of the invention is to provide a communication system which affords a requestor of a certified document a tamper- resistant printing device for printing the issued certified document at a remote location.

A further object of the invention is to provide a communication system operative to establish a fast, reliable and secure communication between a requester of certified documents and an issuer thereof.

Still another object of the invention is to provide a communication system operative to provide an electronic transmission and verification of the information provided by a requestor of a certified document in real time.

Another object of the invention is to provide a communication system operative to establish communication between a requestor of a certified document and a banking institution over a public network and to transmit the certified document over a public network, such as the Internet.

Yet another object of the invention is to provide a communication system operative to identify the requestor's account and sufficiency of funds in response to a request transmitted over the communication system.

Still another object of the invention is to provide a communication system operative to provide reliable security for the certified documents during the issuing, transmitting and printing of these certified documents.

These and other objects are attained by a communication system including a computerized server unit, which is associated with a facility issuing certified documents, a customer communication device and a communication link for exchanging information between the server unit and the customer communication device in such a manner that the issued certified documents can be securely printed at a remote location.

In accordance with one aspect of the invention, the inventive communication system provides for a customer communication device capable of sending a request to issue a certified check to a banking institution. A computerized web server located at the banking institution functions as a front end of an Intrabank communication system, which, upon receiving and processing the request, creates an image file of the requested check. Subsequently, the Intrabank communication system is capable of encrypting the image file sent over to the remote location at which the encrypted image file is decrypted and printed as a certified check.

A further aspect of the invention includes a computerized web server having software for providing communication between a logged in customer and a bank officer who is capable of either manually or automatically approving the customer's request and authorizing issuance of a certified check.

In accordance with a further aspect of the invention, software executing on the computerized server is operative to generate a memo post debit for a customer account and a master memo record for the issuer.

In accordance with yet another aspect of the invention, software executing on a link-up server serving as the outlet end of the Intrabank communication system is capable of initiating a printer located at a remote location associated with a requestor. In this case, software executing on the printer is capable of receiving and decrypting an encrypted image file of the requested certified check directly from the link-up computerized server.

In accordance with another aspect of the invention, a printer can be initiated by a customer communication device, such as PC, which also is capable of receiving and decrypting the image file of a requested certified document.

### BRIEF DESCRIPTION OF THE DRAWINGS

The above and other objects, features and advantages will become more readily apparent from the following description of a preferred embodiment accompanied with the following drawings, in which:

FIG. 1 is a schematic overview of a communication system for printing a certified check at a remote location.

FIG. 2 is a view of a layout of the communication system of FIG. 1.

FIG. 3 is a view of still another layout of the communication system of FIG. 1.

FIG. 4 is an abstract system schematic of the system of FIG. 1 showing logical process flows.

FIG. 5 is a schematic overview of a banking procedure for registering a customer and ordering a certified check.

FIG. 6 is a flow chart of the inventive communication system illustrating a procedure for printing an image file of an issued certified check at a remote location.

FIG. 7 is a flow chart illustrating a general procedure followed by a computerized web server.

FIG. 8 is a flow chart illustrating a step-by-step procedure for processing a customer request and issuing a certified check.

FIG. 9 is a view of a statement generated by the communication system at the end of a predetermined period of time and illustrating the customer's activity.

FIG. 10 is a view of a certified check generated and printed in accordance with the process that is implemented by the communication of FIG. 1.

### DETAILED DESCRIPTION OF THE DRAWINGS

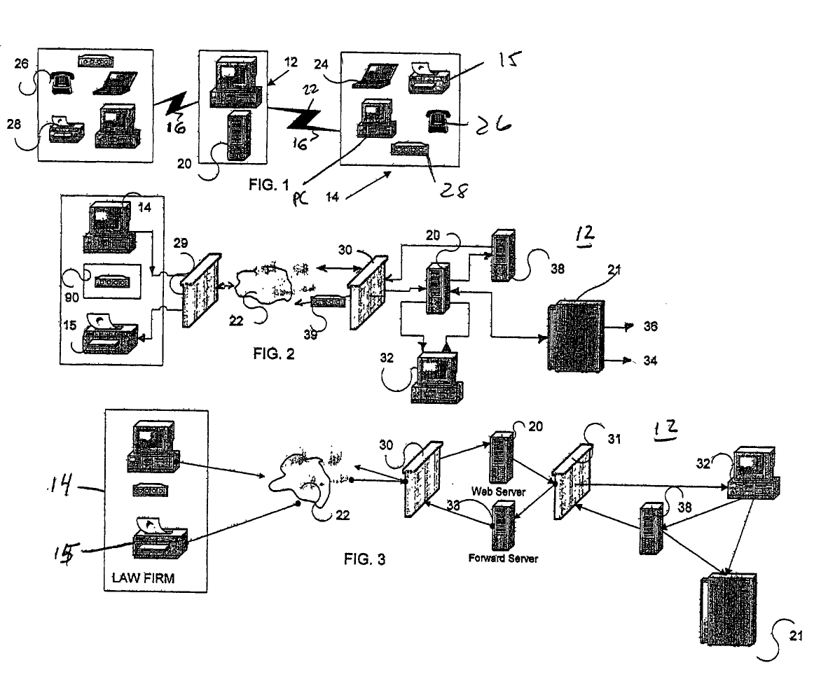

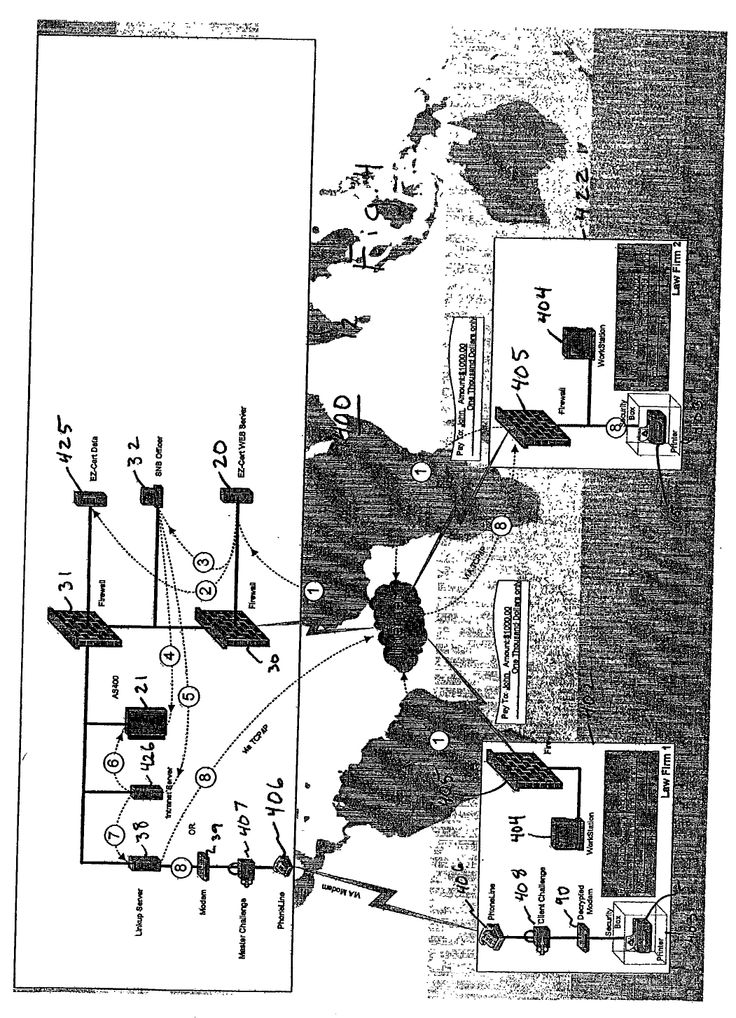

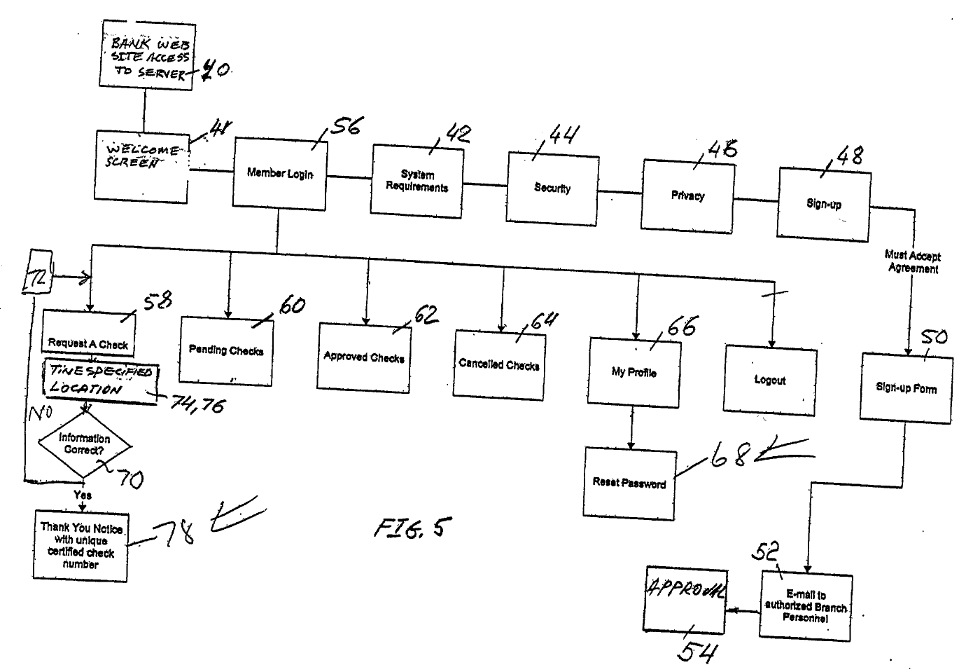

Referring to FIGS. 1-3, a communication system 10 is operative to establish communication between a central location 12, such as a bank, and numerous remotely located customers 14, each of which is associated with a respective printing apparatus 15 (FIGS. 2 and 3) capable of printing certified documents. The communication system 10 allows the customer 14 to connect to the central location through a communication link 16 and to request a certified document that will be created at the central location 12 and printed at the customer's location. The customer 14, who for purely descriptive purposes is an attorney, has an account with the bank 12.

In general, the communication link 16 can be any electronic medium providing the electronic exchange of information between the customer 14 and a server computer 20 of the bank 12 and may include in addition to a public data network, such as the Internet 22 (FIGS. 2 and 3), a private data network, as well as a wireless network 24, a telephone 26 and/or a facsimile system 28. The wireless network, in turn, may include satellite communication, Sprint PCS, GSM, pager systems, and any combination of these. Thus, the inventive system allows the customer to communicate with the bank 12 by establishing various types of communication with the bank through the web server 20.

The physical elements of a customer communication device for carrying out the inventive system include functional and structural components linking the customer 14 with the host or web server computer 20. These can be any electronic devices operative to enable a customer to exchange information with the web server computer 20 or other bank computer servers through the communication link 16. The communication device may include a PC, laptop, PDA-palm pilot in combination with an auxiliary communication device including a facsimile machine, cell phone and traditional telephone systems (POTS). Any of the customer's main and auxiliary communication devices can establish communication between the customer and the bank by transmitting the customer's request for a certified check during actual closing. Alternatively, the customer can submit his/her request in advance of the closing by specifying a desirable time for receiving the certified document and the location of the closing. Thus, whether the customer uses his PC or an auxiliary device, such as a palm pilot or a telephone, software executing on the web server 20 or other bank servers is operative to receive and process the customer's request. Bank 12 preferably has an internal communication system, such as a dedicated intranet for processing and transmitting customer requests. The bank intranet can be spread over several local or remote locations for jointly or separately handling processing steps. Preferably, customer 14 has an option to connect with the bank intranet through a variety of communication schemes including phone lines and internet.

Customer 14 can connect to the bank intranet through the server computer 20 acting as a host, for a web site, a collection of text and image data and executable program data. Server computer 20 is accessible through the internet and, thus, must support initiation and communication from outside. To provide a reliable screening of incoming and outgoing information, the communication system 10 employs at least one firewall 30, as better shown in FIG. 2. The firewall is a data communication security mechanism, which generally operates in two different modes. The first mode is used for masking and identifying systems protected by the firewall and for regulating the source and destination of communication with the protected systems. The other mode or function of the firewall is to monitor data communications for suspicious activity and to counter this activity according to a predetermined protocol. Note, that the firewall 30, as illustrated in FIG. 2, is located on the bank's end. In addition, another firewall 29 can be easily installed on the customer's end of the system.

To further enhance the security of the communication system 10 on the customer's end, it is desirable that customer certificates be used in addition to or alternatively to the customer firewall 29. Such certificates not only help to fine-tune the IP addresses permitted to access the server 20, but they also restrict such an access to specific users. Alternatively, a dedicated phone line may be used to communicate with the bank intranet, as discussed in more detail below.

In accordance with the invention, as shown in FIG. 2, the web server 20 serves only for receiving a request to issue a bank or certified check from the customer 14. The request is further rerouted to an officer terminal 32 for processing by an officer who is assigned to the requesting customer information on the bank intranet communication system. Following the notification and verification procedures, as will be discussed below, the officer may grant the customer's request and, by employing software executing on the officer's computer or manually, release the request on the bank intranet communication system. As a result of such a release, software executing on the web server 20 is operative to generate an image file of the certified check and to transmit the image file to a link-up server 38. Upon receiving the image file, software executed on the link-up server 38 encrypts the image file and further transmits it to the customer 14. Thus, the link-up server 38 is used exclusively for sending the encrypted image through an SSL secured session, which can be connected to the internet 22 either directly or via a dial up modem 39. As a result, the encrypted image file of the requested certified check will be received at the customer location and printed on pre-numbered check paper, which is issued by the bank and securely stored in the printer 15.

After or simultaneously with generating the image file, software executed on the web server 20 provides for transferring funds from a customer's account 34 to a certified check account 36, which is used exclusively by the bank for purposes related to internet Certified Checks. Typically, the web server polls the intranet system at a regular time interval to check if there are any requests approved by the bank officers.

FIG. 3 illustrates another architectural embodiment of the communication system 10 in which an image file is generated and encrypted on the link-up server 38. In contrast to the previously discussed embodiment, here the request to generate a check image file passes directly from the officer terminal 32 to the link-up server 38 after all verification and identification procedures have been completed.

In accordance with this embodiment, the communication system has an additional firewall 31 fronting the bank intranet communication system. Particularly, as is the case with the previously disclosed embodiments, the web server 20 receives a request from a customer and sends it through the additional firewall 31 to the bank intranet communication system. As the request is granted by the officer 32, an encrypted image file of the requested certified check is generated by software executing on the link-up server 38 and is transmitted through the firewall 31 to a forward check server 33. Thus, both, the link-up server 38 and the check forward server 33 do not provide any initiation and communication from outside and serve only for transmitting the encrypted image file to the customer. This embodiment of the system's architecture provides an additional layer of security by having the forward check server 33 separate from the receiving server and two firewalls, which protect the bank intranet system.

Referring now to FIG. 4, a diagram of process flows for the system according to the present invention is illustrated generally as system 400. System 400 is illustrated as having several connectivity means for requesting and receiving official checks, including through an internet TCP/IP connection and a dedicated telephone line with secure modems at either end. Two different examples of connectivity are provided through exemplary check requesters indicated as law firm 1 and law firm 2 having reference designation numerals 402 and 422, respectively. Requestors 402 and 422 each have a printer 15 for printing official checks according to a system of the present invention. Each printer is enclosed in a secure printer security box 403. Security box 403 permits limited access to printer 15, such as, when maintenance or administration of printer 15 is required. An authorized person at requestor 402 or 422 can obtain official checks printed from printer 15 through security box 403, while being prevented from directly accessing printer 15.

The process for obtaining an official check begins with a request from requestor 402 or 422. In the examples shown, requestor 402 and 422 submit a request to a work station that has access to a TCPIP/IP connection to deliver the request through the internet. Although the official check request is shown as being communicated through a TCP/IP connection through the internet, it should be apparent that the system can be arranged to provide the check request through any number of communication media and protocols, including direct phone connections, private networks, wireless connections, and so forth. Requestors 402 and 422 are shown isolated from internet traffic through a fire wall 405, as discussed above. While fire wall 405 is not necessary for the system according to the present invention, it is a typical configuration that is preferable with communications over the internet. The check request communicated by requestors 402 and 422 is delivered to a bank 12 through another fire wall 30 acting as a front end for internet communications with bank 12. The official check request is handled by a web server 20 that handles all interaction between bank 12 and external internet connections. Web server 20 writes out the official check request information to a storage server 425 over the bank intranet system. The official check requests information stored on storage server 425 is used to reference the requestor 402 and 422 to access appropriate data such as balance amounts, stop payments, address, phone numbers and the like. With the official check request information stored on storage server 425, a request for approval is communicated from web server 20 to an approval officer terminal 32, again over the bank intranet system. The approval officer interacts with terminal 32 to verify the request and various information about requester 402 and 422. For example, the approval officer can obtain account information from mini computer 21, which holds customer data and account information. Because of the sensitivity of this data, access to mini computer 21 is illustrated as being obtained through a second fire wall 31 within the bank intranet system. Because account information related to the present invention is also considered to be sensitive, data server 425 is also shown as being accessible through fire wall 31. It should be noted that fire walls 30 and 31 are not essential to the present invention but are used for simplicity and conventional ease of use. Other alternatives for security protection can include encryption schemes, master slave configurations and so forth.

Once the approval officer is satisfied that an official check request can be granted, she can indicate approval by sending a message to intranet server 426 through the bank intranet system. Intranet server 426 generates data related to the check request, including such items as the payee, the amount and information related to requestor 402 and 422. A data file results from the processing at intranet server 426 based on the approval by the approval officer, and the file is transferred to mini computer 21.

Mini computer 21 uses the file generated by intranet server 426 to update account information for requestor 402 and 422. Once the account information on mini computer 21 is updated, bank 12 treats the official check request as having been granted since funds are actually withdrawn or transferred in the accounts maintained by mini computer 21 on behalf of requester 402 and 422. Intranet server 426 then transmits a file to link up server 38, which is capable of establishing a direct intranet connection with requestor 422, for example. In the example where link up server 38 sends the image file of the official check through the internet to requestor 422, printer 15 maintained within requestor 422 is then able to receive the image file over the TCP/IP connection established by link up server 38 to print up the official check on printer 403 at requestor 422.

Another option for transmitting the image file of the approved official check is to transmit the file over phone line through modems 39 and 90. Requestor 402 preferably sends an official check request through a TCP/IP connection over the internet, as described above, and receives the official check at printer 15 through a dedicated phone line 406. Phone line 406 is used to connect to modem 39 and 90 that feature secure transmission techniques. Accordingly, modem 39 can encode the image file to be sent to requestor 402, and modem 90 can decode the encoded file reproduce the image file for printing the official check. The configuration of modem 90 and printer 15 at requester 402 is such that the official check can be printed directly on printer 15 through a direct connection with modem 90. Because this scheme at requestor 402 uses a public telephone line 406, it is preferable that unsolicited telephone calls are blocked from being received at modem 90. Accordingly, the transmission of the image file for the official check from bank 12 includes a master challenge 407 that provides a means of validating the telephone call to modem 90. When the telephone call is placed by modem 39, and received at requestor 402, a master challenge 407 is transmitted to requestor 402. Requestor 402 is both expecting the master challenge, and prepared to respond accordingly, as indicated with client challenge 408. By using the master/challenge scheme depicted for communication between bank 12 and requestor 402, extraneous or unsolicited telephone calls can be blocked through a simple and rapid reimplemented scheme. One technique for implementing the master/client challenge is for master challenge 407 to consist of a code that is transmitted with the encoded image file. When requester 402 receives a call on phone line 406, the incoming telephonic signals are scanned for the code provided by master challenge 407. If the appropriate code is found according to client challenge 408, communication between modems 39 and 90 can take place and the encoded image file can be received, decoded and sent to printer 15. If requestor 402 does not receive an appropriate code in the telephonic signals when receiving a call on phone line 406, the connection is refused.

Although an official check request system 400 has been described with reference to FIG. 4, it should be apparent that various substitutions or eliminations can be made without modifying the fundamental components of the present invention. For example, the configuration of the bank intranet system can be modified in accordance with a variety of schemes, such as schemes that provide for the elimination of fire walls 30 and 31. In addition, the functions of link up server 38, intranet server 426, mini computer 21, data storage server 425 and web server 20 can be consolidated in one computational platform. Many other variations of the present invention, including variations to the logical process flow discussed above, are considered to be within the scope of the present invention, with the above discussions serving as an exemplary model for carrying out the present invention.

Some variations of process flows according to the invention are illustrated in FIGS. 5-8. Referring to FIG. 5, a requestor 402, 422 employing a browser, such as Netscape Navigator or Microsoft Internet Explorer, accesses server 20 of bank 12, and downloads a web page hosted by server 20 as shown in step 40. The downloaded web page is a welcome screen as illustrated in step 41, at which point the user is presented with a menu containing several options for proceeding. Alternatively, the user can be presented with a security screen asking for immediate login. It should be apparent that a number of menu type options may be used in conducting the user through the system according to the present invention. The main features to be considered are appropriate security and limited access, access requests, and management of check requests. The menu system shown in FIG. 5 accordingly illustrates one example according to the system of the present invention.

The menu system shown in FIG. 5 permits a customer or potential user to view system requirements at menu item 42. Although such requirements may vary,, the user is made aware of hardware and software requirements for using system 400. The user can also read details concerning security at menu item 44 and privacy at menu item 46. A user interested in becoming registered with the system can view system policies established by the bank before accepting an agreement form at menu item 48 that contractually obligates the user to follow the rules and regulations affording him/her the benefits of using the inventive communication system. A variety of designs of such an agreement/registration form illustrated in menu item 50 can be easily implemented, and typically this form may include the customer's bank account and all necessary additional personal information. Any of the items on this form can be further used as a unique client identifier (client ID) identifying a customer during subsequent sessions. After the sign-up form in menu item 50 is completed, it is sent to a branch personnel at menu item 52 via an intranet bank communication system, where the customer information can be easily verified using internal bank resources. Upon completion of the verification procedure, the bank notifies the user at menu item 54 that the latter has become a customer who is entitled to use the inventive communication system for the intended purposes. The user can be notified about the customer status in real time, or, alternatively, the bank can use a call-back procedure to contact the user by dialing a phone number or through an e-mail address provided on the registration form.

A customer that is already registered for system access can login at menu item 56. A logged in customer is presented with a variety of options allowing the customer to request a check at menu item 58, to inquire as to the status of pending checks at menu item 60 and/or as to whether the requested check has been approved at menu item 62. In addition, the customer may cancel a previously requested check at menu item 64, view the customer's activity at menu item 66, and/or modify information provided by the customer during a registration procedure, such as resetting the customer's password at menu item 68.

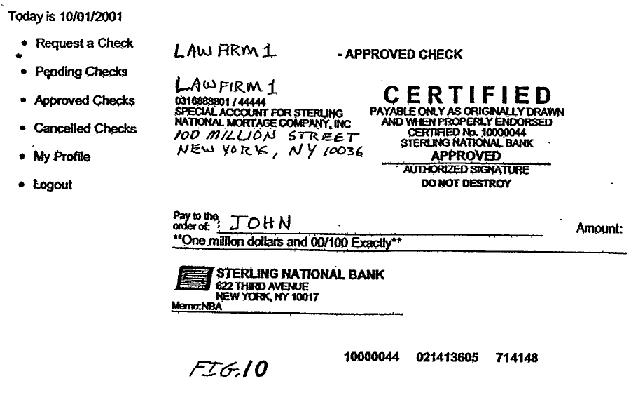

Turning momentarily to FIG. 9, the customer's activity may include, for example, an on-screen summary regarding financial transactions involving the customer. Particularly, such a summary may be a statement indicating a check number, its issuance date and time, as well as a payee's name. The logged-in customer can view a group of such checks issued during a predetermined period of time.

Returning back to FIG. 5, if a customer chooses to request a new check at menu item 58, software executing on the web server may that the customer provide information regarding both a payee, such as the payee's address, and a real estate transaction, such as its location at menu item 74, 76. The customer is given the chance to review the entered information at menu item 70, and make corrections if desired. If the information is incorrect, the customer has an option to reenter the correct information at menu item 72. If the information is correct, a thank you notice at menu item 78 with a unique certified check number appears on a screen at workstation 404, for example, thereby completing communication in real time. For security reasons, a communication session can be limited to a predetermined time, and if the customer cannot complete communication within this time, the system automatically logs the customer out.

A customer, of course, can communicate with the web server 20 while not being physically present in his office, which is typically equipped with the printer 15. Accordingly, the customer contacting the bank by using one of the above-discussed auxiliary devices, such as a cell phone or PDA, can specify a desirable time of printing the requested check at menu item 74. Furthermore, the customer can have more than one location where he conducts his regular business. As a result, the customer can also specify a desirable place of printing at menu item 76, provided that such a place is stored in an address database of the communication system, as will be explained later.

During a registration procedure, in addition to selecting an ID, a customer may be required to provide an access code used to authenticate the customer. One of possible authenticators can be, for instance, a printer identifier (printer ID). In particular, the agreement form addresses the issue of equipment owned or installed at the customer's end. Specifically, the customer may purchase or be provided with a printer which thus would be identified by a specific number used as its ID. Such an ID can be stored in a respective database of the intranet bank system.

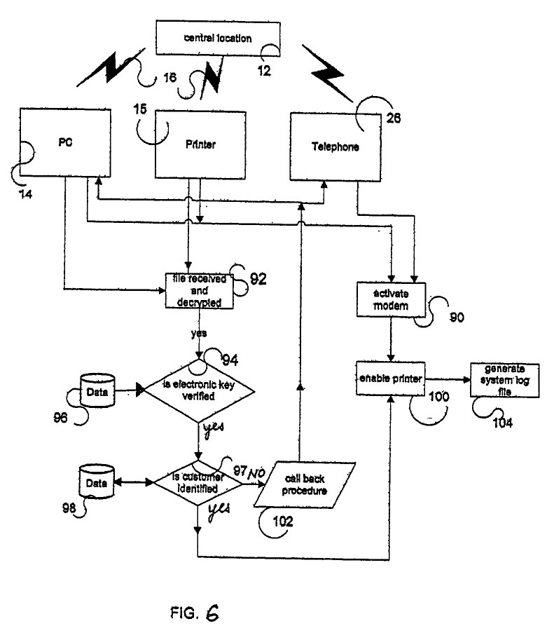

Referring to FIGS. 2 and 6, the printer 15 can be enabled in a variety of ways to print a decrypted image of a certified check which has been created at the central location 12. In accordance with one simple security solution, the customer has an external modem 90 which is placed in a secure box as shown in FIG. 2. Using a key for such a secure box, the customer may open the secure box and plug a phone line capable of making TCP/IP connections into the modem's jack , which serves to couple the printer 15 to the Internet. In this case, the bank can simply call the customer or use software executing on the link-up server 38 for contacting the customer communication device 14, such as a PC, to notify the customer that the certified check requested by the customer is ready for passing through the communication link 16 and that the customer can couple the printer 15 to the internet.

In accordance with one embodiment of the communication system, in addition to a physical key or as an alternative to it, software executing on the link-up server 38 can transmit the encrypted image file of the requested certified check along with an electronic key (FIG. 6). Numerous types of electronic keys are envisioned within the scope of this invention. For example, the electronic key may be an encrypted password that software executing on the modem 90 or printer 15 is capable of verifying. The verification process can include, for example, the steps of decrypting the password and then comparing it to a password stored in the memory of modem 90 or printer 15 or a database 96. If the transmitted and stored passwords coincide with one another, software executing on the printer is permitted to decrypt the image file and actuate a printing mechanism.

In addition, the customer location can be provided with a caller ID unit having software for identifying a caller. The caller ID unit is attached to a telephone line and serves to prevent an attacker or an innocent solicitor from accessing the printer 15 and to inform the customer of attempted violations. As a consequence, even if the printer is coupled to the Internet, it can be enabled only by an authorized source. Such a challenge arrangement was described previously with reference to FIG. 4.

To provide direct communication between the link-up server 38 and the printer 15, the latter is provided with software for decrypting the encrypted image of a check and for recognizing an electronic key which is capable of unlocking the printing mechanism.

Furthermore, it is envisioned within the scope of the invention that, instead of electronically unlocking the printer from the central location, the printer 15 can be electronically enabled by an authorized person at the customer's location. To do so, the authorized person can use any technique that includes the concept of an electronic key capable of making software, which executes on the printer or the customer communication device 14, and actuates the printing mechanism 100. For example, such an electronic key can be associated with biometric data including voice recognition software, fingerprint sensors and/or smart cards, and/or an alphanumerical password. Any information used as an electronic key is verified by software executing on the printer 15 or PC 14. If, for instance, more than one person is authorized to use the printer 15 for the intended purposes, software executed on the PC or printer is capable of querying a database 98 which stores voice patterns or fingerprint templates of all registered users. Upon coincidence of a fingerprint detected by a sensor, which can be an external device or a device integrated, for example, in the keyboard of the PC 14, and one of the fingerprints stored in the database, the printer is enabled to print the certified check. If for any reason, the transmitted image file is not printed or printed improperly, a procedure for canceling the requested check is undertaken, the entire check request procedure can be repeated anew in accordance with the invention as shown in FIGS. 4-7.

In accordance with another embodiment of the inventive communication system, the web server can transmit an encrypted image file of a certified check directly to the customer communication device 14, which is typically a PC, via the internet. In this embodiment, the PC has software for decrypting the image file. To enable the printer, the customer may use either a physical key or an electronic key, as discussed above. Note that any combination of the above-discussed unlocking/decrypting configurations can be implemented within the scope of this invention.

If a request to issue a certified check is filed in advance of an actual closing and specifies a desirable time of printing as well as a location, the customer 14 may be required to be authenticated before transmitting the requested check. For example, software executed on the link-up server 38 can provide communication to any of the customer's main and auxiliary devices and require that the customer call back at step 102. To meet this requirement, the customer may use, for example, a telephone or a PC to contact the bank and undergo a verifying procedure before the printer 15 is enabled to print a certified check. This verifying procedure may include inquiries about a time when the original request was made, account information, password resets, printer and modem information, and the like.

Advantageously, the PC or printer 15 has software for generating a system log file 104. The system log file would provide additional information documenting paper jams, toner condition, and physical access to the printer. Overall, such information can be useful in controlling the pre-printed check stock.

A certified check, as shown in FIG. 10, is printed on standard register safety check stock having control numbers for audit purposes and issued by the bank on a specifically designed secure printer. The certified check is complete with the attorney's logo, and has the bank's facsimile signature for the certification. The check may further have a payee name and, optionally, it can show the name and address of the real estate property in question.

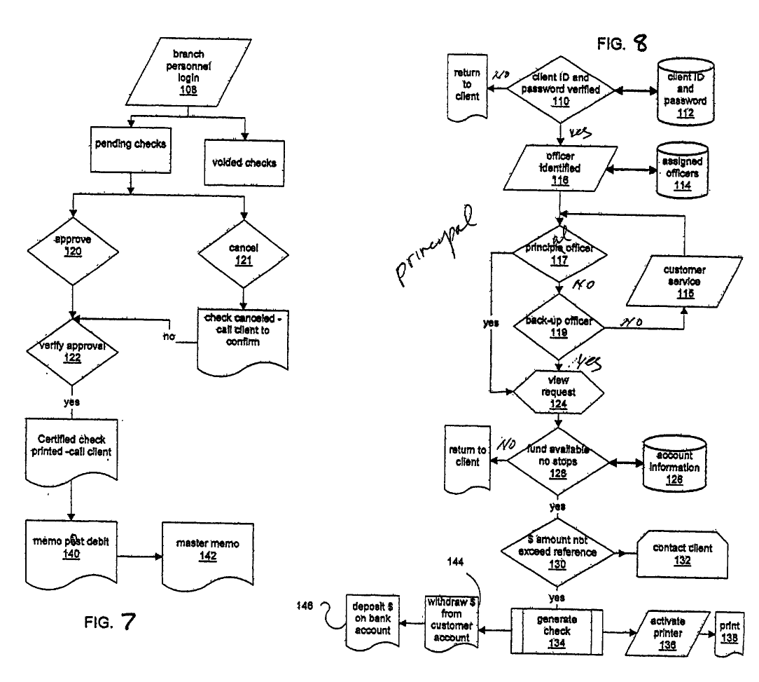

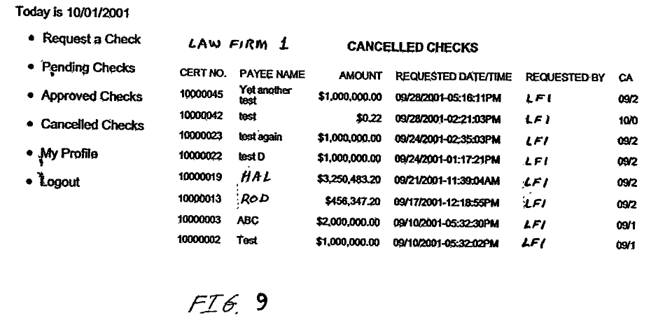

FIGS. 7 and 8 illustrate a series of operations performed at the bank side of the inventive communication system. Specifically, once a request for a certified check has been transmitted and received by a branch personnel 108 through the web server 20, the customer 14 is required to enter his password and access code at 110 (FIG. 8). Each piece of information introduced by the customer is verified upon querying a client database 112 containing, a customer ID, access code and an account number. Based on the customer's information, the system automatically queries a database 114 identifying a principal officer at 116, who is responsible for the identified account number, and/or his assistant at 119.

Once the principal officer is identified, the web server generates an e-mail transmitted through the bank intranet communication system at 117 to the principal officer, or, if communication is not successful, to the officer's assistant 119, who uses the bank intranet communication system to verify sufficiency of funds. If neither of the assigned officers is available, a customer service department 115 will serve as a back-up to ensure that the officer acts upon the request in a timely manner. To attain it, software executing on the customer service department computer can automatically and repeatedly contact a workstation of either of the officers during a predetermined period of time.

As shown in FIG. 7, by using software executing on the officer's computer, the bank officer can either approve or cancel a request at 120 and 121, respectfully. To approve the request, software executing on the officer's computer determines if the customer's account has funds sufficient to cover the customer's request at 128 by viewing the account information which is contained in a customer account database 126. In addition, the account information may provide the officer with other information such as whether there are any stops on the account at 128. If the funds are available, the officer determines whether the requested amount does not exceed a predetermined amount at 130 and, if it does, software executing on the officer PC initiates communication with the customer for verification purposes. This can be accomplished by automatically dialing a telephone number at 132 provided by the customer and stored in the client database 112. Also, communication can include a request made by the officer to the customer via the Internet and requiring the customer to dial the officer's phone number before the certified check is printed.

Once the officer approves the request, it is released on the bank intranet communication system. An image file of the requested and approved check is generated either by the web server 20 or directly by a computer of the link-up system with a unique sequential certified check number. The encrypted file is finally transmitted to the remote location where the printer 15 is actuated at 136 by any of the above-discussed methods to decrypt and print the check at 138. After the check generation procedure has been completed, software executing on the web server 20 generates a memo post debit 140 for the customer account, and further a master memo is created or updated at 142 depending on whether or not it exists at the time of the transaction. Such a memo can include the name of the payee, amount, date, and certified check numbers. Finally, software executing on the web server 20 is capable of electronically transferring money from the customer's account 144 to a certified check bank account 146 (FIG. 8).

Referring again to FIGS. 1-4, a particular feature of the present invention provides additional security for printing official checks requested by an account holder using the system according to the present invention. Printer 15 located at requester 14, 402 or 422 is already potentially enclosed within a secure box that optionally can be opened by a selected authorized individual, and preferably is only accessible to an administrator connected with bank 12, who is unrelated to the operations of requester 14, 402 or 422. In accordance with this embodiment, none of the personnel at requester 14, 402 or 422 can access the printer 15 without an administrator from bank 12 present to open secure printer box 403.

As discussed above, printer 15 can have various capabilities for connection with a modem 90 or a network that is capable of making TCP/IP connections, as illustrated by requester 422. Printer 15 thus has computational capacity, in addition to storage memory for carrying out verification and printing of official checks, in addition to various other computational tasks. A particular memory for printer 15 can be provided to encode an authorized signature for printing on the official check that is printed by printer 15. For example, when requester 14, 402 or 422 becomes registered with bank 12 to use the system according to the present invention, an agreement or contractual relationship can be entered into such that printer 15 can print official checks and imprint official signatures onto the checks when they are printed. In accordance with these agreements or contractual relationships, an administrator from bank 12 can insert into printer 15 a memory containing a specifically authorized signature for imprinting on an official check. Because the official check is already approved by bank 12 at the time that the image file is received by requester 14, 402 or 422, the imprinting of an official signature at the remote location reflects the previously given approval in accordance with the agreement between the requester 14, 402, 422 and bank 12. According to one embodiment, the official check is imprinted with two official signatures, one from an authorized signatory from bank 12, and one signature from an authorized signatory from requester 14, 402 or 422.

The administrator from bank 12 that inserts the memory containing the authorized signature matches the particular signature according to the fonts available on printer 15. It is therefore feasible to have a number of remote locations for a given requester, each of which has a printer with a memory chip containing an authorized signature, and while each of these signatures are for the same authorized signatory, each signature appears different at the different locations in accordance with the fonts and signature memory installed on the printer 15 at the various remote locations. In this way, it would be possible to determine where an official check was printed within a requesting entity that has multiple offices.

In accordance with the above-described configuration, an authorized signature is not sent with the image file of the approved check, but rather is imprinted on the check at printer 15 of requester 14, 402 or 422. If a new authorized signature is required, an administrator from bank 12 visits the site of printer 15 at requester 14, 402 or 422 to update the signature memory so that any new authorized signatures can be imprinted on the checks as they are being printed locally. In a typical check request transaction, the check image file is sent to printer 15 as described above, and is printed on the check stock along with the authorized signature of an authorized bank signatory and an authorized signatory of the requester 14, 402 or 422. This countersigning feature according to the present invention permits an additional level of security for official checks, while maintaining a high level of automation. For example, the authorized signatory for requester 14, 402 or 422 need not be present for an official, countersigned check to be issued.

It is contemplated that the system according to the present invention can be used in any type of situation where the remote printing of a secure document is required. In addition to validation of the document at a remote site, the present invention provides secure authorized signatures locally at the requester's site. Because the signatures can be stored in memory on the printer, they are not limited to personal signatures of individuals, but rather can include verification and validation data related to the transmitted document. For example, the store authorization information can include a private key of a public/private keypair for decrypting or certifying the transmitted image file.

Although the present invention has been described in relation to particular embodiments thereof, many other variations and modifications and other uses will become apparent to those skilled in the art. Therefore, the present invention should be limited not by the specific disclosure herein, but only by the appended claims.

What is claimed is:

1. A communication system for printing certified checks at a remote customer location, comprising:
a customer communication device operative to send a customer request for issuing a certified check;
a web server operative to receive and process the customer request and to generate an image file of the requested certified check upon processing the customer request;
a link-up system coupled to the web server for receiving the image file and operative to transmit the image file via a communication link; and
a printer located at the remote customer location and coupled to the link-up system via the communication link, whereby the printer is operative to print the certified check upon receiving the transmitted image thereof.

2. The communication system defined in claim 1, wherein the customer communication device comprise one of a PC, desktop, PDA-palm pilot, 2-way pager, phone and a combination of these.

3. The communication device defined in claim 1, wherein the web server is coupled to the communication link for receiving the customer request.

4. The communication system defined in claim 1, wherein the web server is located at a central location and has software for communicating with an intrabank network of the central location, the intrabank network including a plurality of computerized workstations in communication with one another and with the web server for transmitting and receiving information pertinent to the customer request, the image file of the certified check having a sequential certified check number of an official certified check bank account, a payee's name, the requested amount and a logo of the customer identification.

5. The communication system defined in claim 1, wherein the web server is operative to provide a registration procedure for a first-time customer in response to communication initiated by the customer device.

6. The communication system defined in claim 5, wherein the web server has software executing thereon to display a sign-up form in response to the first-time customer request, the sign-up form including a variety of questions related to personal information.

7. The communication system defined in claim 6, wherein the web server has software executing therein for assigning a customer identifier during the sign-up procedure, the customer identifier being selected from the personal information, the web server further having software executing thereon for identifying the customer during subsequent communication sessions between the central unit and the customer communication device.

8. The communication system defined in claim 5, wherein the web server has software executing thereon for allocating an authentication access code to the customer during the sign-up procedure.

9. The communication system defined in claim 1, further comprising a customer database accessible by the web server and storing customer identifiers and customer authentication access codes, the web server being operative to retrieve the stored customer code and access code in response to the customer's request and to process the customer's request in response to positive authentication of the customer corresponding to coincidence between the inputted customer identifier and access code and the retrieved identifier and access code.

10. The communication system defined in claim 9, further comprising an account number database accessible by the web server which has software executing thereon for retrieving an account number of the customer in response to the customer's positive authentication.

11. The communication system defined in claim 9, wherein the web server has software executing thereon for providing the customer with information as to a status of a pending certified check requested by the customer after the latter has been positively authenticated, for canceling the requested certified check in response to the customer's request, and for obtaining a statement illustrating the customer's activity for a predetermined period of time.

12. The communication system defined in claim 10, further comprising a bank representative database accessible by the web server upon the positive authentication of the customer, the bank representative database storing at least one named e-mail address of a first bank representative who is assigned to a customer's account corresponding to the account number.

13. The communication system defined in claim 10, wherein the web server computer has software executing thereon for forwarding the customer request and the retrieved account number to the computerized workstation of the first bank representative via the intrabank network.

14. The communication system defined in claim 13, wherein the computerized workstation of the first bank representative has software executing thereon for confirming the forwarded customer request and account number, the web server computer further having software for forwarding the customer's request to a second bank representative provided with a respective computer if the first bank representative is not accessible within a predetermined period of time.

15. The communication system defined in claim 14, further comprising a back-up customer computerized workstation receiving the request from the web server computer if neither the first bank representative nor the second bank representative is reachable within the predetermined period of time, the back-up customer workstation being provided with a respective computer which has software executing thereon for periodically contacting the workstations of the first and second bank representatives if neither of the first and second bank representatives has been reached.

16. The communication system defined in claim 14, wherein the workstations of the first and second bank representatives each is operative to access the customer's account via the intrabank network for verifying the sufficiency of funds and presence of stops.

17. The communication system defined in claim 16, wherein the computerized workstations of the first and second bank representatives each has respective software for posting approval of the customer request on the intrabank network upon verifying the sufficiency of funds on the customer's account.

18. The communication system defined in claim 17, further comprising software executing on the web server computer for periodically checking the approvals released on the intrabank network.

19. The communication system defined in claim 14, wherein the computerized workstations of the first and second bank representatives each has respective software for initiating communication with the customer communication device if the requested amount exceeds a predetermined reference amount for confirming the requested amount.

20. The communication system defined in claim 4, wherein the web server has software for transmitting the generated image file to the link-up system via the intrabank network, the link-up system being provided with software for encrypting the image file and for transmitting the encrypted image file via the Internet to the remote location.

21. The communication system defined in claim 4, wherein the web server has software for creating a memo post debit file for the customer account and a master memo record for the official certified check bank account.

22. The communication system defined in claim 4, further comprising a first firewall fronting the central location and operative to screen incoming requests and outgoing information.

23. The communication system defined in claim 22, further comprising another firewall located so that the web server is flanked by two firewalls.

24. The communication system defined in claim 23, further comprising a forward check server located between the firewalls and being in communication with the link-up system for transmitting the encrypted image file of the certified check to the remote location through the communication link.

25. The communication system defined in claim 4, wherein the printer receives the encrypted image file of the issued certified check directly from the central location, the printer having software for decrypting the received image file, the link-up system having software executing thereon for electronically enabling the printer upon transmitting the encrypted image file.

26. The communication system defined in claim 20, further comprising a an external modem coupled to the printer, and a housing lockably encasing the external modem and having a lock operated by the customer to access the housing and connect the external modem to a telephone line after the location has notified the customer that the encrypted image file is ready to be transmitted.

27. The communication system defined in claim 1, wherein the customer communication device is coupled to the link-up system for receiving the encrypted file image of the certified check and has software executing thereon for forwarding the transmitted image file to the printer.

28. The communication system defined in claim 26, wherein the customer communication device further has software executing thereon for decrypting the transmitted encrypted image file of the certified check and software for enabling the printer.

29. The communication system defined in claim 1, further comprising a customer firewall fronting the remote location.

30. The communication device defined in claim 1, further comprising software executing on the printer for generating a system log file including information documenting paperjams, toner condition, and physical access to the printer.

31. The communication device defined in claim 1, further comprising a sensor for authenticating the customer based on the customer's biometric data and coupled with the customer communication device and the printer, at least one of which has software executing thereon for recognizing the detected biometric data and for enabling the printer in response to the recognition of the detected biometric data.

32. A communication system for printing certified checks at a customer location comprising:
a customer communication device operative to send a customer request for issuing a certified check to the central unit;
a web server located at the central unit and operative to receive and process the customer request;
a link-up system coupled to the web server for generating an image file of the requested certified check upon processing the customer request, the link-up system being operative to transmit the image file of the certified check via a communication link; and
a printer located at the remote customer location and coupled to the link-up system via the communication link, whereby the printer is operative to print the certified check upon receiving the transmitted image thereof.

33. A method for printing a certified check at a remote location, comprising the steps of:
transmitting a customer request to issue a certified check to a central location;
creating an image file of the requested certified check at the central location in response to receiving the customer request;
transmitting the image file via the communication link to the remote location; and
printing the issued certified check upon receiving the image file at the remote location.

34. The method defined in claim 33, further comprising a step of providing the central location with at least one firewall fronting a web server.

35. The method defined in claim 34, further comprising a step of providing communication between a web server coupled to the communication device and an intrabank network operating at the central location, the intrabank network including a plurality of computerized workstations in communication with one another for transmitting and receiving information pertinent to the customer request.

36. The method defined in claim 33, wherein the customer communication device is coupled to the web server via the communication link, the method further comprising a step of registering a first-time customer in response to communication initiated by the customer device.

37. The method defined in claim 36, wherein the step of registering includes displaying a sign-up form in response to the first-time customer request and requesting personal information to assign a customer a customer identifier and a customer authentication code.

38. The method defined in claim 37, further comprising steps of storing the customer identifier and authentication access code in a database allocated to the customer during a sign-up procedure, retrieving the stored customer identifier and access code inputted by the customer during communication sessions subsequent to the sign-up procedure, comparing the inputted identifier and access code with the stored customer identifier and access code, and approving the customer request in response to positive authentication of the customer if the inputted identifier and access code and the retrieved identifier and access code coincide.

39. The method defined in claim 38, further comprising the steps of retrieving a customer account number in response to the customer's positive authentication, and displaying information pertinent to the retrieved customer account number for approving a new certified check requested by the customer.

40. The method defined in claim 35, further comprising a step of generating an e-mail containing the customer request by the web server and sending the e-mail to a bank representative, who is assigned to supervise the customer account, via the intrabank network.

41. The method defined in claim 40, further comprising a step of periodically re-transmitting the e-mail to the bank representative if a previous attempt to contact the bank representative was unsuccessful until at least one bank representative, who is responsible for approval of the customer request, is reached.

42. The method defined in claim 41, further comprising the steps of verifying sufficiency of funds deposited on the customer account and presence of stops thereon by the bank representative and of posting a request approval on the intrabank network if the customer account contains sufficient funds and there are no stops.

43. The method defined in claim 42, further comprising a step of periodically surveying the intrabank network for detecting the request approvals and for forwarding the detected request approvals to the web server.

44. The method defined in claim 43, wherein the web server generates the image file upon receiving the request approval, the image file of the certified check being created with a sequential certified check number of an official certified check bank account, a payee's name, the requested amount and a customer identification.

45. The method defined in claim 44, further comprising the steps of transmitting the generated image file to the link-up system via the intrabank network, encrypting the image file on the link-up system and transmitting the encrypted image file via the Internet to the remote location.

46. The method defined in claim 45, further comprising steps of transferring the requested amount from the customer account to an official certified check bank account and creating a memo post debit file for the customer account and a master memo record for the official certified check bank account.

47. The method defined in claim 42, wherein the request approval is transmitted directly to the link-up system.

48. The method defined in claim 47, wherein the link-up system generates the image file and encrypts the generated image file.

49. The method defined in claim 48, further comprising the steps of providing another firewall so that the at least the one and the other firewalls flank the web server, and providing a forward certified check server located between the at least one and the other firewalls and coupled to the link-up system for receiving the encrypted image file of the certified check to transmit the received encrypted image file to the remote location.

50. The method defined in claim 48, further comprising steps of contacting the remote location before transmitting the encrypted image file, accessing a housing lockably enclosing an external modem which is coupled to the printer and a telephone line, thereby coupling the printer to the link-up system via the communication link.

51. The method defined in claim 50, further comprising a step of enabling the printer directly from the link-up system.

52. The method defined in claim 50, further comprising the step of enabling the printer by detecting biometric data of the customer.

53. The method defined in claim 50, further comprising the step of enabling the printer from a communication device located at the remote location and comprising of a PC, desktop, PDA-palm pilot, 2-way pager, phone and a combination of these.

54. The method defined in claim 50, further comprising steps of transmitting the image file directly to the printer from the link-up system and decrypting the transmitted file before printing it at the remote location.

55. The method defined in claim 50, further comprising a step of transmitting the image file of the certified check from the link-up system to the communication device and decrypting the encrypted image file before printing the certified check.

56. A communication system according to claim 1, further comprising:
a storage memory in the printer for storing information accessible to the printer; and
an authorization indicia in the storage memory for providing remote check authorization.

57. A communication system according to claim 56, wherein the authorization indicia is an authorized signature.

58. A communication system according to claim 57, wherein the authorization indicia includes a plurality of authorized signatures.

59. A communication system according to claim 32, further comprising:
a memory storage in the printer and accessible to the printer for providing an indicia of authorization for the certified check.

60. The communication system according to claim 59, wherein the authorization indicia is an authorized signature.

61. A method according to claim 33, further comprising printing an indicia of authorization on the issued certified check at the remote location.

62. The method according to claim 61, wherein the indicia of authorization is a signature by an authorized signatory.

63. The method according to claim 33, further comprising providing a memory storage in a printer for printing the issued certified check, wherein the memory storage contains an indicia of authorization.

64. A system for printing a certified check at a remote location, comprising:
a financial institution maintaining accounts upon which certified checks may be written;
a request to the bank to prepare a certified check for the remote location;
a bank system for preparing an image file of a certified check based on an account and an approval by the bank;
a communication link to the remote location for transmitting the image file from the bank to the remote location; and
a printer at the remote location and coupled to the communication link to print the certified check.

65. The system according to claim 64, further comprising a storage memory in the printer for storing an indicia of authorization for the certified check.
